(19) United States
(12) Patent Application Publication
(10) Pub. No.: US 2017/0291721 A1
(43) Pub. Date: Oct. 12, 2017

(54) ENHANCED FUEL TANK FOR MOBILE GROUND POWER UNIT

(71) Applicant: ILLINOIS TOOL WORKS INC., Glenview, IL (US)

(72) Inventor: Leslie TINDALL, Kingswood, Kent (GB)

(21) Appl. No.: 15/515,839

(22) PCT Filed: Sep. 10, 2015
(86) PCT No.: PCT/US2015/049293

§ 371 Date: Mar. 30, 2017

(30) Foreign Application Priority Data
Oct. 10, 2014 (EP) 14188511.1

(51) Int. Cl. B64F 1/36; H02K 7/18

(52) U.S. Cl. CPC B64F 1/364; H02K 7/1815

(57) ABSTRACT

The disclosure relates to a Mobile ground power unit for supplying power to an aircraft parked on the ground, the ground power unit comprising an engine, an electric generator, whereby the electric generator is configured to be driven by the engine, a housing whereby the engine and the electric generator are disposed within the housing, and a fuel tank, wherein the fuel tank comprises a wall that forms at least one channel that allows air to pass from one side of the fuel tank to another side of the fuel tank. The disclosure further relates to a fuel tank for a ground power unit.

### RELATED APPLICATIONS

The present application is a National Phase of International Application Number PCT/US2015/049293, filed Sep. 10, 2015, and claims priority to European Application Number 14188511.1 filed Oct. 10, 2014.

### BACKGROUND

This invention relates to ground power units (GPU) for supplying power to an aircraft parked on the ground.

Such a ground power unit is disclosed in U.S. Pat. No. 5,253,891 A. It usually comprises an engine, driving an electric generator, both inserted in a housing to protect it from environmental influences.

### SUMMARY

The inventor found it very disadvantageous that it is difficult to get fresh, dry air to the generator for cooling the generator, because of the lack of space where the generator is usually located.

The object of the invention therefore was to provide fresh, dry air to the generator.

This object is achieved by the subject matter of the independent claims; preferred embodiments are specified by the dependent claims.

Particularly, this object is achieved by a mobile ground power unit for supplying power to an aircraft parked on the ground, the ground power unit comprising
an engine, which is preferably a combustion, particularly preferable diesel engine, and
an electric generator, whereby the electric generator is configured to be driven by the engine,
a housing whereby the engine and the electric generator are disposed within the housing,
a fuel tank, wherein the fuel tank comprises a wall that forms at least one channel that allows air to pass from one side of the fuel tank to another side of the fuel tank.

The object of the invention is also achieved by a fuel tank for a ground power unit wherein the ground power unit comprises
an engine, which is preferably a combustion engine, and
an electric generator, wherein the electric generator is configured to be driven by the engine,
a housing whereby the engine and the electric generator are disposed within the housing,
   wherein the fuel tank comprises a wall that forms at least one channel that allows air to pass from one side of the fuel tank to another side of the fuel tank.

The object of the invention is also achieved by a method for operating a ground power unit according to one of the previous claims, whereby
air is passed from one side of the fuel tank to another side of the fuel tank by the at least one channel.

Thereby, dry clean and cool air can be drawn from below the GPU without spending much more space for suitable ducting components, as the tank itself acts as a ducting component. As a very beneficial side effect, the inventor found out, that the air passing the fuel tank is cooling the fuel inside the fuel tank.

Preferably, the mobile ground power stands on wheels. Usually, it is equipped with a towing arm. The GPU is preferably set up to output 28 V of direct current and/or 115 V 400 Hz of alternating current. Preferably, the electric energy is carried from a generator to a connection on the aircraft via cables, for example a 3 phase 4-wire insulated cable capable of handling 261 A (90 kVA).

Preferably, the housing of the ground power unit is a component or group of components that surrounds the engine and/or the generator at least partially, particularly at the sides and/or the top of engine and/or generator. The housing is preferably the outer shell of the ground power unit.

The generator in a GPU requires dry, clean and cool air for cooling. A large volume of air is required which means that the precipitation can be drawn in if the intake opening is exposed to the weather. Another issue with modern diesel engines is keeping the fuel cool. Diesel fuel is used as a coolant to cool the injector pump and is returned warm to the fuel tank. The fuel returning from the injector pump gradually increases the temperature of the tank. If the fuel temperature exceeds the limits defined by the engine manufacturer then an additional fuel intercooler is required. By drawing the generator cooling air through a, preferably molded, duct in the fuel tank it is possible to remove heat from the fuel without having to add a separate cooler to the fuel circuit.

Preferably, the other side of the fuel tank is a side approximately perpendicular to the one side, particularly preferable it is the other side of the fuel tank is approximately parallel vis-à-vis the one side. Preferably, the tank is located below generator and engine.

When the fuel tank is installed inside the GPU, the channel is allowing air to pass from one side of the fuel tank to another side of the fuel tank. Preferably, the air being passed from one side of the fuel tank to another side of the fuel tank is driven by a ventilator. Particularly preferable, the ventilator (or fan) is located on or in the housing of the ground power unit. Preferably, air is blown from the inside of the housing to the outside of the housing by that ventilator, whereby fresh air is being sucked from the outside of the housing to the inside of the housing and whereby that fresh air or at least a part of that fresh air is the air being passed from one side of the fuel tank to another side of the fuel tank, i.e. fresh air is being sucked by the ventilator from one side of the fuel tank to another side of the fuel tank. Preferably, the ventilator is the exhaustion ventilator of the ground power unit, which is rotationally coupled to the engine and/or generator. Preferably the ground power unit has a ventilator that is respectively set up.

In a further preferred embodiment of the GPU or the fuel tank according to the present invention, the fuel tank is rotor molded or rotor cast, or a rotor molded or rotor cast component, preferably out of plastic, e.g. Polyethylene.

One of the down sides of using polyethylene tanks is that the material insulates the fuel better than steel tanks and it is more likely that fuel coolers are required. However, by incorporating the channel into the fuel tank, this down side is compensated for and one can on the other side benefit from the advantages a rotor molded/cast component offers (e.g., low cost, impact resistance, chemical resistance, etc.). Therefore, one can use a rotor molded/cast tank, esp. Polyethylene tank, without increasing the fuel temperature.

Preferably, the channel is located in the tank at a position that is—when the tank is disposed inside the housing of the GPU—below and vis-à-vis the generator or below and at one side of the generator such that the generator is in between the channel and an ventilator and therefore and air stream will hit the generator. Particularly preferably, the channel is positioned precisely at a generator air intake.

In a further preferred embodiment according to the present invention the wall of the fuel tank is surrounding the channel except for an inlet opening and an outlet opening of the channel.

Thereby, the effective surface for cooling the fuel is high. The channel is completely passing through the tank which also provides for an advantageous air flow.

In a further preferred embodiment according to the present invention the channel has an inlet on the bottom side of the fuel tank and an outlet on the top side of the fuel tank.

Thereby, cool dry air is able to enter from below and to be drawn through the tank vertically. This enables an effective air flow with short flow distances.

### BRIEF DESCRIPTION OF THE DRAWINGS

Embodiments of the present invention will now be described—by way of example only—with reference to the accompanying drawings, whereby

FIG. 1 is a sketch of a GPU according to the invention, having a fuel tank according the invention,

FIGS. 2a-2f are drawings of a GPU according to the invention based on FIG. 1 and incorporating as well many of the advantageous preferred features.

### DETAILED DESCRIPTION OF THE DRAWINGS

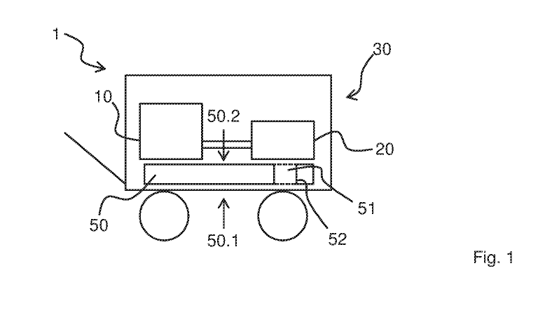

FIG. 1 is showing a side view of a GPU 1 according to the invention having a fuel tank 50 according the invention. The GPU 1 comprises an engine 10 and an electric generator 20. The electric generator 20 is configured to be driven by the engine 10. The GPU 1 comprises a housing 30 whereby the engine 10 and the electric generator 20 are disposed within the housing 30. The fuel tank comprises 50 a wall 51 that forms at least one channel 52 that allows air to pass from one side 50.1 of the fuel tank 50 to another side 50.2 of the fuel tank 50.

This allows having an air intake into the housing through the fuel tank 50, resulting in less space needed for this function and additional cooling of the fuel.

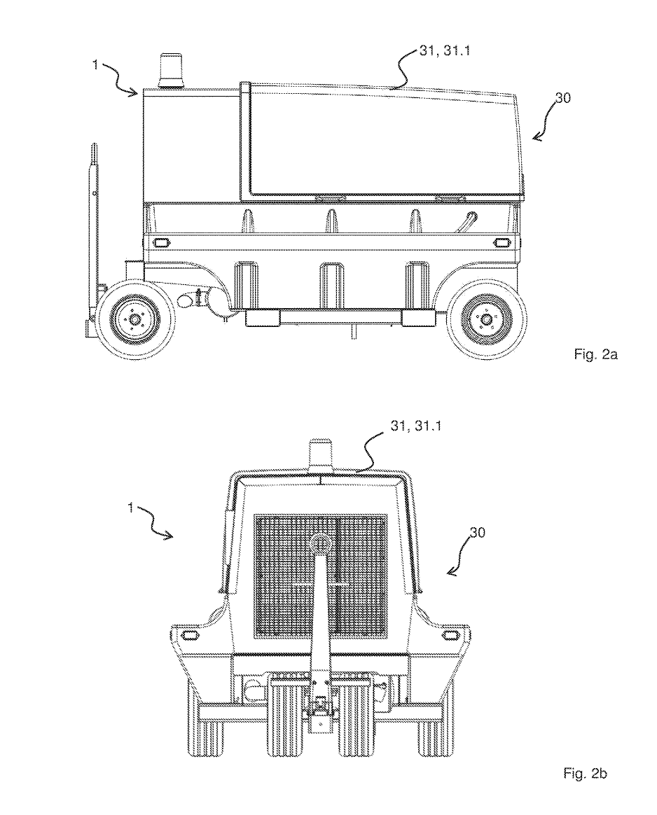

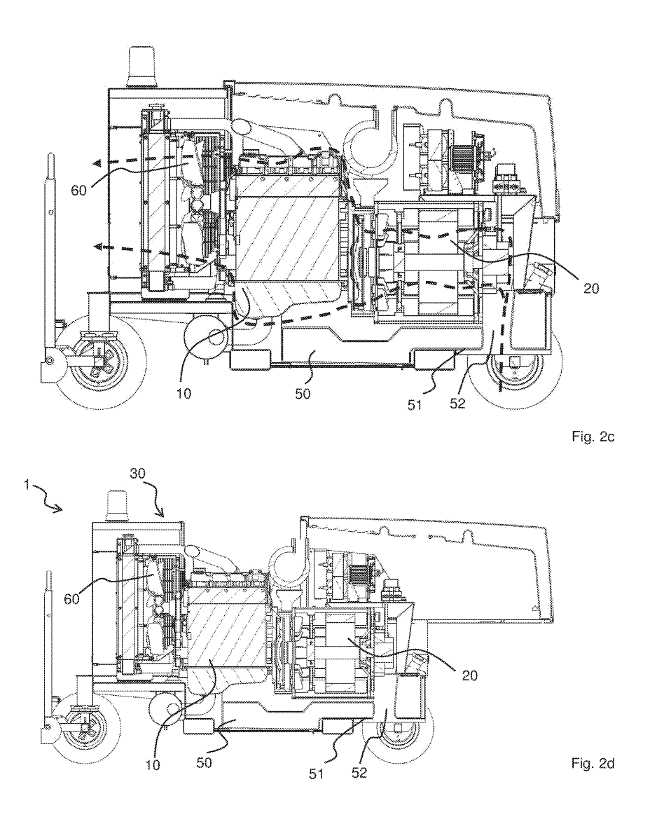

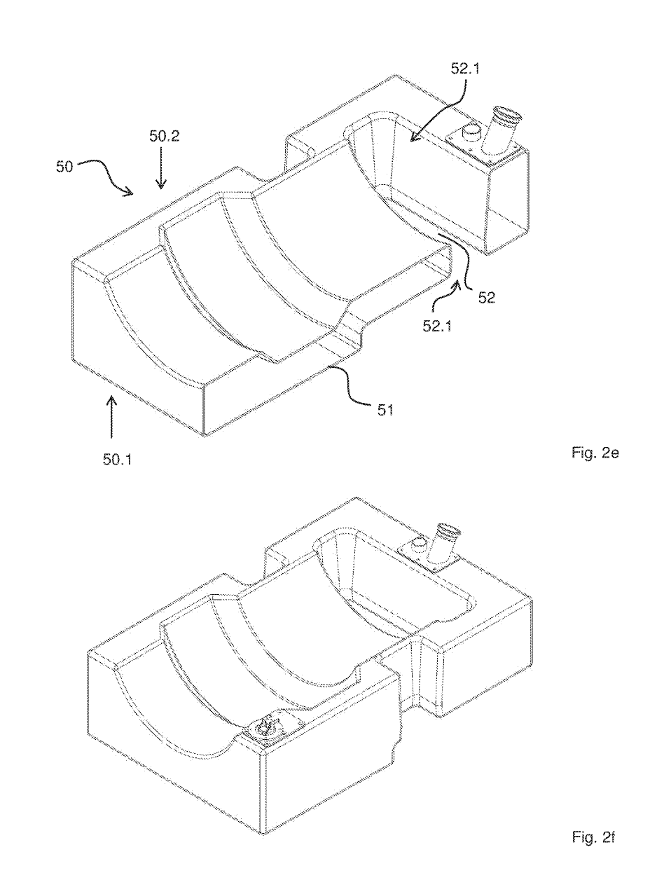

FIGS. 2a-2f are showing a GPU 1 according to the invention based on FIG. 1 incorporating as well many of other advantageous preferred features. FIG. 2a is a side view, FIG. 2b a frontal view, FIG. 2c and d cross-sectional views, wherein in FIG. 2d, the canopy is retracted, FIG. 2e a section through the fuel tank and FIG. 2f the complete fuel tank.

The housing 30 features as a component 31 a canopy 31.1, which preferably is rotor molded or rotor cast, and which covers at least the upper side of the engine 10 and the generator 20.

The GPU 1 comprises a fuel tank 50 below generator and combustion engine, wherein the fuel tank 50 comprises a wall 51 that forms at least one channel 52 that allows air to pass from one side 50.1 of the tank to another side 50.2 of the fuel tank 50. The wall 51 of the fuel tank 50 is surrounding the channel 52 except for an inlet opening 52.1 and an outlet opening 52.2 of the channel 52. The channel 52 has an inlet on the bottom side of the fuel tank 50, which is the side 50.1, and an outlet on the top side of the fuel tank 50, which is the side 50.2. The channel 52 is located in the tank 50 at a position that is below and at one side of the generator 20 such that the generator 20 is in between the channel 52 and a ventilator 60 of the liquid cooling aggregate and therefore, an air stream will hit the generator 20. The channel 52 is furthermore positioned precisely at a generator 20 air intake. In FIG. 2c, the air flow due to the channel 22 is depicted by dashed arrows.

With this invention, a better fuel tank for a GPU is provided. Incorporating a channel through the fuel tank enhances the possibilities for better air circulation and it even helps cooling the fuel. The subject matter described in this application (applicant's reference 65757 (713-3726)) is also connected to further inventions, described in two additional applications marked with applicant's reference 65755 (713-3728) and 65756 (713-3727), which are hereby incorporated by reference.

1. Mobile ground power unit for supplying power to an aircraft parked on the ground, the ground power unit comprising
an engine and
an electric generator, whereby the electric generator is configured to be driven by the engine,
a housing whereby the engine and the electric generator are disposed within the housing,
a fuel tank
wherein
the fuel tank comprises a wall that forms at least one channel that allows air to pass from one side of the fuel tank to another side of the fuel tank.

2. Ground power unit according to claim 1, wherein the fuel tank is rotor molded or rotor casted.

3. Ground power unit according to claim 1, wherein the wall of the fuel tank is surrounding the channel except for an inlet opening and an outlet opening of the channel.

4. Ground power unit according to claim 1, wherein the channel has an inlet on the bottom side of the fuel tank and an outlet on the top side of the fuel tank.

5. Method for operating a ground power unit according to claim 1, whereby
air is passed from one side of the fuel tank to another side of the fuel tank by the at least one channel.

6. Fuel tank for a ground power unit wherein the ground power unit comprises
an engine and
an electric generator, wherein the electric generator is configured to be driven by the engine,
wherein the fuel tank comprises a wall that forms at least one channel that allows air to pass from one side of the tank to another side of the fuel tank.
